(19) United States
(12) Patent Application Publication
(10) Pub. No.: US 2015/0315886 A1
(43) Pub. Date: Nov. 5, 2015

(54) WELL TREATMENT WITH HIGH SOLIDS CONTENT FLUIDS

(71) Applicants: Dmitry Ivanovich Potapenko, Sugar Land, TX (US); Svetlana Viktorovna Nesterova, Novosibirsk Region (RU); Bruno Lecerf, Houston, TX (US); Maxim Grigorievich Ivanov, Novosibirsk Region (RU); Diankui Fu, Kuala Lumpur (MY); Marina Nikolaevna Bulova, Moscow region (RU)

(72) Inventors: Dmitry Ivanovich Potapenko, Sugar Land, TX (US); Svetlana Viktorovna Nesterova, Novosibirsk Region (RU); Bruno Lecerf, Houston, TX (US); Maxim Grigorievich Ivanov, Novosibirsk Region (RU); Diankui Fu, Kuala Lumpur (MY); Marina Nikolaevna Bulova, Moscow region (RU)

(21) Appl. No.: 14/363,333

(22) PCT Filed: Dec. 9, 2011
(86) PCT No.: PCT/RU2011/000971

§ 371 Date: Dec. 11, 2014

(51) Int. Cl. E21B 43/16; C09K 8/42

(52) U.S. Cl. CPC E21B 43/16; C09K 8/426; C09K 2208/08

(57) ABSTRACT

A method is given for reducing the flow of a treatment fluid in a well, for example for zonal isolation or for stimulation fluid diversion. The method includes preparing a High Solids Content Fluid (a pumpable slurry containing a carrier fluid and a packed volume fraction of at least 50 per cent solids having a multi-model size distribution), injecting the high solids content fluid into the well, placing the high solids content fluid at the location at which fluid flow is to be decreased, and either reducing the volume or increasing the viscosity of the carrier fluid. Optionally, at least a portion of the solids in the High Solids Content Fluid is subsequently removable to restore fluid flow.

### BACKGROUND

The statements in this section merely provide background information related to the present disclosure and may not constitute prior art.

Recovery of hydrocarbons often requires performing multi-stage fracture stimulation treatments. Such treatments use repeating steps of zonal treatment and isolation of the treated zone. Major types of such treatments include fracturing operations, high-rate matrix treatments and acid fracturing, matrix acidizing and injection of chelating agents. Another important application of zonal isolation is well drilling in a permeable or fissured formation, which frequently results in losing a significant part of the drilling fluid into the formation. While such losses in permeable formations can be greatly minimized by using various fluid loss agents, preventing fluid loss in fractured formations is still a major problem.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter. A method is given for reducing the flow of a treatment fluid in a well including a wellbore penetrating a subterranean formation. The method involves preparing a slurry including a high solids content fluid made using a carrier fluid and solids having a multi-model size distribution, injecting the high solids content fluid into the well, placing the high solids content fluid at the location at which fluid flow is to be decreased, and either reducing the volume of the carrier fluid or increasing the viscosity of the carrier fluid.

### BRIEF DESCRIPTION OF THE DRAWINGS

Embodiments are described with reference to the following figures. The same numbers are used throughout the figures to reference like features and components.

FIG. 1 is a schematic of a particle size distribution of a multi-modal mixture with which embodiments of the well treatment may be implemented.

FIG. 2 illustrates apparatus for demonstrating how embodiments can be implemented.

FIG. 3 shows results of a test of one embodiment.

FIG. 4 shows the displacement of a plug in an example embodiment.

### DETAILED DESCRIPTION

It should be noted that in the development of any actual embodiments, numerous implementation-specific decisions may be made to achieve the developer's specific goals, for example compliance with system- and business-related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating embodiments and should not be construed as a limitation to the scope and applicability. Although some of the following discussion emphasizes fracturing, the fluids and methods may be used in many other well treatments. Embodiments are applicable to wells of any orientation. Embodiments may be described for hydrocarbon production wells, but it is to be understood that embodiments may be used for wells for production of other fluids, for example water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

This application discloses a method of using a slurry containing a multi-modal mixture of solid particles for isolating or plugging wellbore intervals, fractures, or formation zones during multi-stage fracturing and other treatments (including matrix acidizing and acid fracturing (fracture acidizing) of carbonates, water control, treatment of carbonates with chelating agents, squeezing scale control or other control agents, and any other operations that require setting a plug in a wellbore or in a formation, including during drilling and workover operations). The method can be used to plug or block fluid flow in any flow path, for example wellbores, vugs, natural and manmade fractures, channels, and wormholes. Such a pumpable (“flowable”), mobile, slurry in a carrier fluid is called here a High Solids Content Fluid (HSCF). The method involves pumping the HSCF downhole where either a) the volume of the continuous liquid phase of the slurry is reduced (“dehydration”) so that the solid volume fraction exceeds the packed volume fraction, or b) the viscosity of the continuous liquid phase of the slurry is increased to the point at which the slurry does not flow under the applied fluid pressure; either action can cause the formation of a mechanically stable plug. The plug may be chemically removable or permanent. In each portion of the following discussion, technique a) (volume reduction or “dehydration”), will be emphasized first, followed by technique b) (viscosity increase), although many statements in all discussions apply to both. Whenever we refer to formation of a plug, such formation is understood to be inferred from a reduction in well and/or treatment fluid flow.

A reduction in the volume of the continuous liquid phase may be induced by using many mechanisms, including fluid absorption by absorbing agents, reaction of fluid with some of the solid components of the slurry, fluid leak-off (for example into a manmade or natural fracture or vug), precipitation of part of the continuous phase, and breakdown of a multi-phase fluid. The particle size distribution in multi-modal mixtures of solid particles may be engineered to control the porosity and permeability of the plug created using models based on the ratios of different particle sizes and the distribution. The mixture of solid particles may also include at least one degradable and/or dissolvable and/or removable component, the disappearance of which will increase the plug permeability.

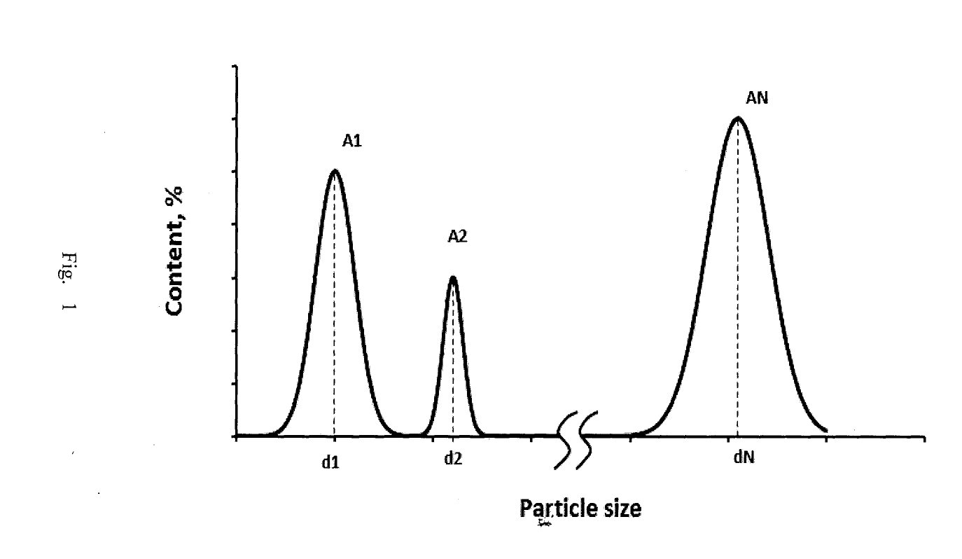

By a multimodal mixture of solid particles we mean mixtures of grains comprising particles of at least two distinct average sizes. Often the particle sizes are discrete and do not overlap as illustrated in FIG. 1, in which the areas under each curve A1, A2 . . . AN are the amounts of each particle size and d1, d2 . . . dN are the average particle sizes. Such multimodal mixtures have been described in U.S. Pat. No. 7,833,947, hereby incorporated by reference in its entirety. A non-limiting example of the teachings of that patent is a method of delivering a first chemical component to a subterranean formation in a wellbore comprising: providing a fluid comprising a carrier fluid and at least two different sizes of solid particulate materials selected from a group consisting of: very large particles, large particles, medium particles, fine particles, very fine particles and ultrafine particles; wherein the packed volume fraction of the two sizes of solid particulate materials in some embodiments exceeds 0.50, in some other embodiments exceeds 0.64, and in some further embodiments exceeds 0.8; and wherein a first type of solid particulate materials contains the first chemical component able to be released by a first downhole trigger and a second type of solid particulate materials contains the first chemical component or a second chemical component able to be released by a second downhole trigger; pumping the fluid into the wellbore; and allowing the first chemical component to be released by the first downhole trigger. Embodiments may be used with all the combinations and permutations of the above example disclosed in U.S. Pat. No. 7,833,947, as well as with any of the mixtures of particle sizes disclosed for various downhole uses in the literature, for example those described in U.S. Pat. Nos. 5,518,996, 7,402,204, 7,833,947, 7,923,415, 7,784,541, 6,656,265, 6,874,578, 6,626,991 and 7,004,255 and EP Patent No. 1152996. In general, a High Solids Content Fluid is defined as a pumpable fluid having at least two, preferably at least three, suitable size ranges, and consequently a packed volume fraction of at least about 50 percent, sometimes at least about 64 percent, sometimes at least about 80 percent (the close random packing value of packed volume fraction for monodispersed spheres).

The advantages of using multi-modal mixtures of solids for plug creation by slurry dehydration or slurry fluid viscosity increase include the following
Using multi-modal mixtures having suitable particle size distributions allows preparation of slurries having significantly lower contents of the liquid phase than fluids that have particles of one mode. Therefore:
   less liquid must be removed from the system (or viscosified) for plug creation.
   even small changes in the properties of the continuous phase may have a major effect on the HSCF fluidity.
   plugs formed have a high solids content and so have much higher mechanical stability than plugs having lower contents of solid particles.
Lower fluid content of the slurry makes the volume of the slurry comparable to the volume of the plug created. Otherwise, free fluid generated from the diverting slurry after it bridges may overdisplace proppant-containing slurry from the near-wellbore zone which will have a negative impact on well production.
Using multi-modal mixtures having some specific particle size distributions allows control of the permeability of the created plug, by varying the size of all particles at constant pore size distribution, or by varying the pore size distribution at constant particle size, always within the constraint of having a packed volume fraction (PVF) of at least 50%, sometimes at least 64%, and sometimes at least 80%. Curves for permeabilities as functions of particle size distributions and particle sizes can be drawn from experiments done in the lab.
Fluids that comprise high contents of multi-modal mixtures of solid particles are more stable than fluids that comprise just one size of particle. This significantly reduces the risk of slurry separation due to particle settling, as was shown in U.S. Pat. No. 6,626,991.
Using degradable particles in the multi-modal mixture, including adding a degradable material in addition to the HSCF solids, adds additional functionality to the system and allows subsequent reduction of the permeability of the plug formed.

Embodiments include a method of zonal isolation or plugging by dehydrating or increasing the viscosity of the fluid phase of a slurry which comprises a multi-modal mixture of solid particles (HSCF). The method includes:
Preparing a slurry that includes a multi-modal mixture of solid particles and a carrier fluid
Pumping the prepared slurry downhole
Dehydrating or increasing the viscosity of the slurry downhole (plug creation), and
Optionally decreasing plug permeability with time.

### Preparing the Slurry

The slurry is prepared by mixing the multi-modal mixture of solid particles and a carrier fluid. Mixing may be performed on-the-fly during pumping or by preparing the slurry in a batch mixer prior to pumping. For on-the-fly mixing, flow-through blenders may be used. Batch mixing may be performed, for example, using mixers designed for mixing cements or drilling fluids. The sections below provide detailed descriptions of some suitable components of the slurry

The multi-modal mixture of solid particles for preparation of HSCF's contains particles having at least two, and preferably at least three, modes of particle size distribution as shown in FIG. 1. Varying the content of particles of different modes in the mixture allows controlling the packed volume fraction (PVF). To increase the PVF of a two particle size mixture, the size of the smaller particles is preferably comparable to or smaller than the size of the void space between the larger particles. For three-modal particle size distributions, the sizes of the intermediate particles are preferably comparable to or smaller than the sizes of the voids between the largest particles and the sizes of the smallest particles are preferably comparable to or smaller than the sizes of the voids between the particles of the intermediate sizes. Four or more particle size distributions may be used. Particles size distributions meeting such specifications may have PVF's as high as 90%. It is known, that mixtures with high PVF factors require minimal volumes of fluid added to obtain slurries having high fluidities. For example, using the described tri-modal mixtures of particles allows achieving pumpable slurries having about 50% solid material by volume, sometimes about 64% solid material by volume, sometimes about 80% solid material by volume, sometimes about 90% solid material by volume. For comparison, typical concentrations of mono-modal solid particles in a fracturing fluid normally do not exceed 30% by volume.

In embodiments, the multi-modal mixture of solid particles may include particles of various types. It may be sand, ceramic and/or glass beads, synthetic proppant, plastics and polymers, carbonates, salts, wax, paraffin, nut shells, and many other materials, including all solids that have been or will be pumped down a well. Some components of the mixture may also be removable, that is degradable, soluble/dissolvable or meltable at downhole conditions so that at some time they disappear from the plug that was initially formed. Non-limiting examples of the removable materials include:
materials that may be used for making degradable particles, for example polyesters, for example polylactic acid, its copolymers, and polyglycolic acid and its copolymers; polyamides; polycaprolactam; polypeptides; polyurethanes; polyethers, and mixtures of such materials
Soluble and/or dissolvable materials, for example many salts soluble in water, for example sodium chloride, potassium chloride, and others; waxes and polymers soluble in oil and organic solvents, for example paraffins, oil soluble resins; salts and polymers that may be dissolved or hydrolyzed by acids, for example calcium and magnesium carbonate, cellulose and its derivatives, and others; and chemicals that may be dissolved or hydrolyzed by alkaline agents, such as active metals like Mg and Al, benzoic acid, polyesters, and others.
materials that may be meltable under downhole conditions, for example waxes; paraffins; benzoic acids; naphthalenes; gilsonites; those polymers meltable at downhole temperatures, for example polycaprolactones, polypropylvinyl ethers, polypropylene oxides, polytrans-isoprenes, polybutylvinyl ethers, polyethylene oxides, and others

Fluids that may be used for preparing slurries include, but are not limited to, water; brine; gelled water; slick-water; aqueous solutions of at least one polysaccharide, for example guar and its derivatives, alginate and its derivatives, and cellulose and its derivatives; aqueous solution of polyvinyl alcohol; solutions of crosslinked polymers, for example guar and its derivatives, diutans, alginate and its derivatives, cellulose and its derivatives; emulsions; foams; and others. In other embodiments non-aqueous fluids may be used, for example oils; diesel; gelled oils; organic solvents; tributoxy ethanols; alcohols, and others. In yet other embodiments, VES fluids may be used; VES fluid viscosity may be increased by changing the ionic strength, or by changing the pH. The fluids may also include various additives, especially soluble additives to give the fluids special properties. Non-limiting examples include clay stabilizing agents, thermal stability agents, iron control agents, and others. Fluids may also contain at least one type of solid particles having a shape different from the shape of the particles in the multi-modal mixture. Non-limiting examples include fibers (including nanofibers, for example nanocellulose fibers), rods, plate-like particles, and others. These additional solid particles may also be removable and may be made of the same types of materials as the removable portions of the multi-Once prepared, embodiment slurries be pumped downhole using the same pumping equipment as used for fracturing, matrix acidizing, cementing and well drilling. Downhole, the slurry may be injected into the formation or allowed to stay in the wellbore before dehydrating or viscosifying.

### Plug Creation by Dehydrating the Slurry Downhole

Numerous mechanisms may be used to dehydrate a multi-modal particle-containing HSCF slurry; embodiments include:

Absorbing Liquid by Particles

At least one kind of particle in the multi-modal mixture or in the fluid may have fluid absorbing properties. The volume of such particles may increase with fluid absorbtion (that is, the particles are swellable) or may remain unchanged. A fluid containing either type of particles downhole undergoes a reduction in the amount of liquid phase in the slurry, which reduces the fluidity of the mixture and causes plug creation. A beneficial side effect of the swelling is that with the increased size of some of the particles in the slurry there is an additional factor reducing the mobility of the slurry.

Examples of suitable water-swellable materials include but are not limited to crosslinked polysaccharides, for example crosslinked guar and its derivatives, crosslinked alginate and its derivatives, crosslinked or non-crosslinked cellulose and its derivatives; crosslinked polyols, for example polyvinyl alcohols; crosslinked polyacrylamides; water swellable clays, for example bentonite; suitable cement particles; and others. The following may, for example, be used as crosslinking agents: salts of metals, for example Ca, Mg, Ti, Zr, Fe, Al, Ni, Cr, and Cu; boric acid and its derivatives; di- and polyaldehydes, for example glutaric aldehyde, and others. Certain polymers may also be crosslinked by exposure to radiation. Water swellable elastomer compositions may also be used for slurry dehydration. Typical methods of making such compositions include incorporation of water-swellable polymer material in an elastomeric matrix, with optional vulcanization at the end of the process; examples are given in U.S. Pat. No. 6,358,580; U.S. Pat. No. 4,590,227; and WO 2009/021849. Non-limiting examples of particles that may absorb fluid without a significant volume change include zeolites, glass membranes, salts which are able to form crystalline hydrates, highly crosslinked polymers, and others. An embodiment utilizing dehydrating a slurry containing a tri-modal mixture of solid particles in which one size is swellable is illustrated in Example 1 below.

### Precipitating a Portion of the Continuous Phase

Causing precipitation of a portion of the continuous phase may be achieved by reaction of at least one soluble component in the continuous phase with another component that is initially part of the solid particles of the slurry. Some non-limiting examples of chemical reactions that result in creating insoluble precipitates include: reactions of low-molecular weight chemicals, for example salts, forming insoluble salts, or insoluble complexes of polymeric components; for example:
reactions of soluble calcium salts, for example CaCl₂, with soluble carbonates, for example Na₂CO₃ or K₂CO₃, which results in formation of insoluble CaCO₃.
reactions of soluble calcium salts, for example CaCl₂, with certain carbonic acids, for example terephthalic or oxalic acids, which results in formation of substantially insoluble calcium salts. For example, the reaction of CaCl₂ with terephthalic acid gives the substantially insoluble calcium terephthalate. The terephthalic acid for this reaction can be obtained by hydrolysis of polyethylene terephthalate, which initially can be present in the slurry in various different forms including particles, fibers and flakes.
reaction of soluble salts of metals having a valence of +2 or more with soluble hydroxides or with salts of strong bases and weak acids. For example reactions of AlCl₃ or MgCl₂ with NaOH or KOH, which results in the formation of insoluble hydroxides, for example Al(OH)₃ or Mg(OH)₂. It should be pointed out that some such insoluble hydroxides may possess amphoteric properties, for example like Al(OH)₃ may be dissolved in an excess of NaOH, so the amount of added soluble hydroxide may need to be controlled.
formation of precipitates of polymeric components of the mixture brought about by forming insoluble salts of soluble polymers or by crosslinking such soluble polymers with the formation of insoluble complexes or complexes of crosslinked polymers having significantly lower solubility (fluid syneresis). Non limiting examples of polymers which form insoluble salts or complexes with metals having a valence of +2 or more ions include polyacrylamides; polymers having carboxylic groups, for example alginates, carboxymethyl hydroxypropyl guar (CMHPG), carboxymethyl cellulose (CMC), polyacrylic acid, and others. Examples of solutions of polymers and crosslinked polymers that demonstrate syneresis include alginate, crosslinked guar, and others. For example crosslinking of alginate with Ca²⁺ or Al³⁺ ions results in the formation of rigid alginate complexes having high water content, as shown in Example 2 below.

Additional embodiments of systems whose dehydration is brought about by precipitation of part of the continuous phase are described in Examples 3 and 4 below.

In some embodiments, it may be desirable to delay the formation of insoluble precipitates; in such cases, some components of the slurry that may give insoluble precipitates in reaction with soluble components may be in encapsulated form or in a form that enables gradual release of the components into the continuous phase. For example, grains of such components may be coated with substantially insoluble or slightly soluble coatings. These components may then enter the continuous phase by shear destruction of capsules, by diffusion through the coating, or by at least partial dissolution of the coating. Alternatively, such coatings may be destroyed by chemical agents. These mechanisms allow control of the time of formation of the insoluble precipitates, and therefore enable control over the placement the plug. Example 5 below shows an embodiment using a coated component for controlling the formation of insoluble precipitates.

Using Water-Reactive Chemicals

In other embodiments, water based slurries are effectively dehydrated by addition of water-reactive agents. Examples of such agents include, but are not limited to, oxides, for example MgO, CaO, and others; cements; and active metals, for example Al and Mg. In one embodiment, MgO reacts with water, giving practically insoluble magnesium hydroxide Mg(OH)₂. It should be noted that the volume of the reactive particles in this reaction increases by a factor of about four, which may be an additional factor in reducing the fluidity of the slurry.

Fluid Leak-Off

Fluid leak of into the formation is another mechanism of slurry dehydration. In this case the slurry is injected into the fracture, and the fluid leaks off either into the formation or into the fracture. The remaining solids form a plug; the permeability depends upon the composition of the original multi-modal mixture.

Destabilizing a Multiphase Carrier Fluid

Destabilization of multi-phase carrier fluids may result in a significant reduction in the fluidity of the system. Emulsions are examples of such multiphase systems that may be destabilized, for example by addition of surfactants, addition of solvents, changing the salinity and increasing the temperature. Destabilizing a water-bitumen emulsion, such as those used in road construction, by adding ethoxybutanol results in precipitation of bitumen and a significant reduction of the fluidity of the mixture. The same happens with commercially available PLA emulsion as illustrated below in Example 6.

### Setting the Plug by Viscosity Increase

The prepared slurry can be pumped downhole using the same pumping equipment as used for fracturing, matrix acidizing, cementing and well drilling. Downhole, the slurry may be injected into the formation or left in the wellbore before creation of the plug. Any systems used to delay viscosification of fluids being pumped downhole (for example to reduce hydraulic horsepower requirements) may be used. The carrier fluid of the slurry is mixed with a chemical agent that will result in increasing the viscosity of the fluid downhole. Some non-limiting examples of such agents are salts of borate or transitions metals, for example Ti, and Zr, for polysaccharide-based carrier fluids or solutions of polyols; and salts of transition metals, for example Zr, and Cr for polyamide based carrier fluids. Increasing the viscosity of the carrier fluids can be delayed using chemical delaying agents (for example sugars and their derivatives for the reactions of polysaccharides with borate salts). Alternatively, the mixture may be activated by shear in perforations if the agent responsible for increasing the fluid viscosity is coated and the coating is destroyed by shear. In yet other embodiments, VES (viscoelastic surfactant) fluids may be used; VES fluid viscosities may be increased by changing the ionic strength, or by changing the pH. For example, many VES fluid systems have low viscosity in acid but much higher viscosity as the pH is increased; reaction of such a carrier fluid with a source of base, for example with a carbonate formation, can set a plug. Some examples of systems suitable for plug generation by viscosity are shown in examples 7 and 8.

### Plug Removal

If zonal isolation is intended to be temporary, the conductivity of the plug may be increased after the plug is no longer needed. For this several mechanisms may be used; examples include:

Degradation.

Some components of the original multimodal mixture may be made of degradable materials. Examples of such materials are described above in the discussion of the preparation of the slurry. Bottomhole temperature increases speed-up degradation processes and eventually degradable materials disappear. When the degradable particles are smaller than non-degradable particles, the degradation may result in an increase in permeability of the plug without complete removal of the plug; this is valuable if the plug is propping up a manmade fracture that the operator wants held open. If the plug is in a natural fracture, vug, or wormhole, then it may not be necessary to prop it open and any or all of the particles introduced may be degradable. If the plug is in the wellbore or a perforation, it may be important to ensure that the plug is completely removable by using degradable particles that are larger than any non-degradable particles or by using all degradable particles.

Dissolution and/or Chemical Destruction.

This mechanism is similar to the degradation mechanism except that a special dissolution agent may be injected into the plug to cause at least partial dissolution. Examples of materials that can be used are also described above in the discussion of the preparation of the slurry. Chemical destruction is also a useful mechanism for removing residues of the used carrier fluid. For example, when fluid crosslinking is used as a dehydration mechanism, the crosslinked fluid may be destroyed by decrosslinking agents or by destructors of polymer chains. It is well known that crosslinked guar can be effectively destroyed by oxidizers, for example NH₄S₂O₈, NaBO₃, and others. Alginate crosslinked with calcium can be destroyed by acid, for example citric acid, or by the same oxidizing agents. Note that acid may be produced inside the plug if polyesters (for example PLA) are used as part of the original multimodal mixture. Many polymers can be destroyed by enzymes. One embodiment is decrosslinking of alginate complexed with Ca²⁺ by lactic acid formed by hydrolyzing PLA.

Melting.

If some components of the original multi-modal mixture are meltable, then temperature recovery will cause their removal from the plug. Examples of materials that potentially can be used in that way are described above in the discussion of the preparation of the slurry

### Examples

Any elements of the disclosed embodiments may be replaced by any one of numerous equivalent alternatives, only some of which are disclosed in the specification.
Embodiments can be further understood from the following examples.

### Example 1

### Slurry Dehydration by Water-Absorbing Particles

Alginate/Ca²⁺ complex particles were prepared by incubating 2000 ml of a 2% alginate solution in an oven at a temperature between 50° C. and 80° C. with 133 ml of a 1% solution of CaCl₂ for 24 hours. The complex formed was then washed with deionized water and put back into the oven at 50 to 80° C. for further drying. The solid mass obtained was then milled and the particles having sizes between 0.43 mm and 0.84 mm were selected. 10 g of the swellable 0.43 to 0.84 mm size alginate/Ca²⁺ complex particles were added to the slurry composition given in Table 1. Further swelling of the alginate/Ca²⁺ particles turned the slurry to a solid-like substance.

TABLE 1

| Multi-modal composition | Fluid |
|---|---|
| CarboProp 16/20 Proppant | 18 ml of 0.24% guar |
| 0.584-0.838 mm 56 g | solution in water |
| CaCO₃ (mean diameter 101 | |
| microns) 15 g | |
| CaCO₃ (mean diameter 8.0 | |
| microns) 22 g | |

### Example 2

### Syneresis of Alginate/Ca²⁺ Complex

An alginate/Ca²⁺ complex was prepared by mixing 20 ml of a 2% alginate solution with 2 ml of a 10% CaCl₂ solution. As a result of gel syneresis, after 1 hour 5.3 g of alginate/Ca²⁺ complex and 14.7 ml of non-gelled water was obtained.

### Example 3

### Formation of Insoluble Alginate/Ca²⁺ Complex

A slurry was prepared with the multi-modal composition and fluid described in Table 2. When 0.5 ml of a 10% solution of CaCl₂ was added, formation of an insoluble complex having a high water content resulted in a significant reduction in the fluidity of the slurry.

TABLE 2

| Multi-modal composition | Fluid | Additive |
|---|---|---|
| CarboProp 16/20 Proppant | 9 ml of 2% | 0.5 ml of |
| 0.584-0.838 mm 28 g | solution of | 10% solution |
| CaCO₃ (mean diameter 101 | sodium | of CaCl₂ in |
| microns) 7.5 g | alginate in | water |
| CaCO₃ (mean diameter 8.0 | water | |
| microns) 5.5 g | | |

### Example 4

### Creating a Plug by Dehydrating a Slurry

A slurry containing the tri-modal mixture of solid particles and the alginate solution described in Table 3 was prepared.

TABLE 3

| Multi-modal composition | Fluid |
|---|---|
| CarboProp 16/20 Proppant | 36 ml of 2% solution of |
| 0.584-0.838 mm 112 g | sodium alginate in water |
| CaCO₃ (mean diameter 101 | |
| microns) 30 g | |
| CaCO₃ (mean diameter 8.0 | |
| microns) 22 g | |

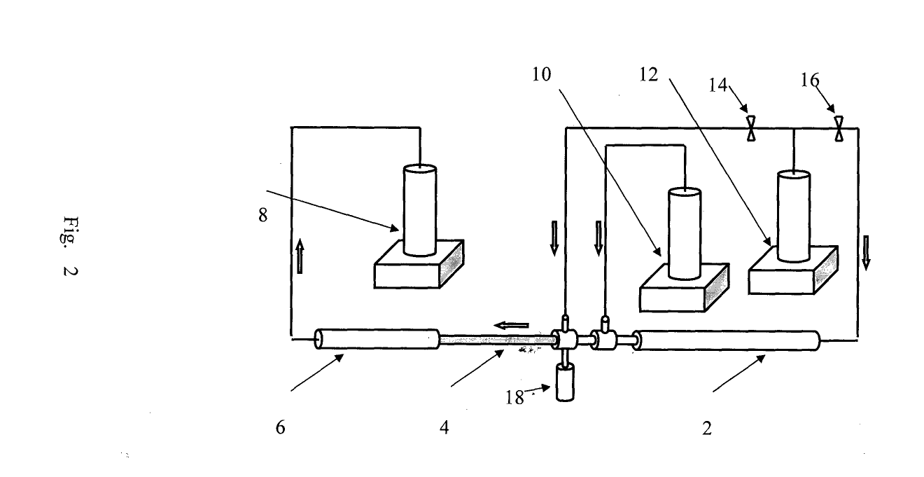

The apparatus used is shown in FIG. 2; it includes an accumulator [2] for initially containing the slurry, a slot [4], a receiving accumulator [6], three pumps (Pump A [8], Pump B [10], and Pump C [12]) and a pressure transducer [18]. The slot was made from a 1.27 cm (½ inch) pipe having an inside diameter of 10 mm by gluing a monolayer of 100 mesh (mean diameter 101 microns) sand to the internal surface. The length of the slot was 500 mm. Flow directions are shown by the open arrows. At the start of the experiment, the previously prepared slurry was placed into the accumulator and the rest of the system was filled with water, except that Pump B and the line between Pump B and the system were filled with an 8% solution of CaCl₂. Pump A was set to maintain 0.689 MPa (100 psi) pressure at the outlet side of the slot. Before starting pumping, slurry valve 1 [14] was closed and valve 2 [16] was open. During the experiment, the slurry was displaced from the accumulator by pump C while injecting CaCl₂ solution into the system. The rates for Pump C and Pump B were 10 ml/min and 1 ml/min respectively.

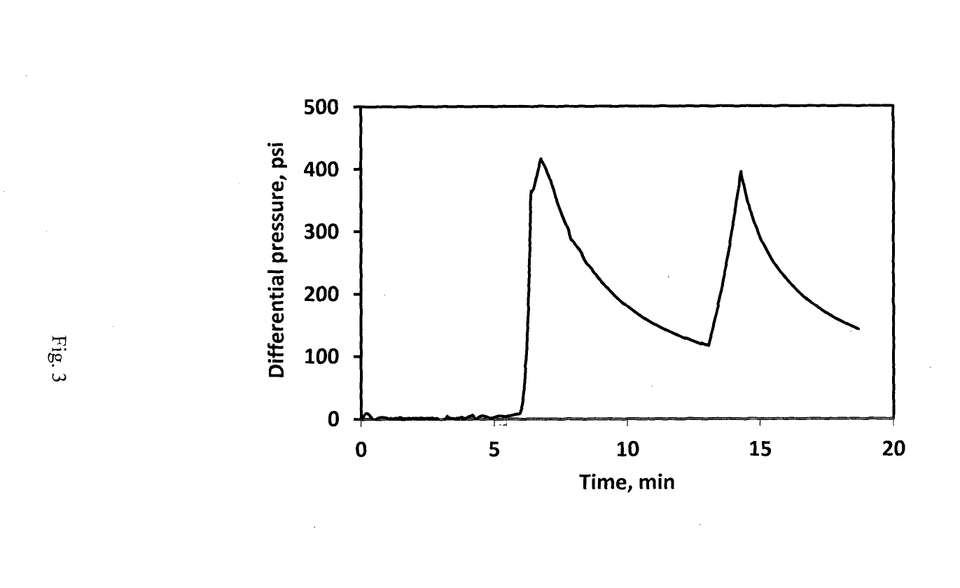

FIG. 3 shows the dependence of the differential pressure across the slot measured during the experiment with the pressure transducer. As was shown in Example 3, crosslinking by adding calcium chloride (at about 6 minutes into the experiment shown in FIG. 3) to an alginate-containing slurry significantly reduced the fluidity of the slurry. In the present experiment, crosslinking created a plug in the slot, as indicated by the pressure increase in the system within 1 minute of starting the addition of the CaCl₂ mixture. The system was shut down at about 7 minutes into the experiment because the system pressure limit had been reached. The pressure decayed due to very slow flow through the plug until about 13 minutes. Then, to evaluate the plug stability, an attempt was made to displace the plug from the slot with water from pump 3 by opening valve 1 and closing valve 2. The plug could not be displaced at a differential pressure of more than 2.757 MPa (400 psi) and the rate of water leaking through the plug was less than 0.1 ml/min. After the experiment, the system was taken apart and it was found that the length of the plug formed in the 500 mm slot was 382 mm.

### Example 5

### Encapsulated CaCl₂ to Control Formation of Insoluble Precipitates

An alginate/Ca²⁺ complex was prepared by mixing 20 ml of a 2% alginate solution with 1 g of commercially available encapsulated CaCl₂ grains having a size of from about 1 to 2 mm (NutriCAB™, 80% CaCl₂, available from Soda Feed Ingredients S.A.R.L., Monaco). The commercially available NutriCAB™ grains had been washed several times with deionized water to remove possible traces of free CaCl₂ and then dried on a glass vacuum filter. Mixing of the alginate solution with the encapsulated CaCl₂ grains provided a slurry having a uniform distribution of particles and high fluidity. Ten minutes after the mixing, the properties of the slurry remained unchanged. To cause release of CaCl₂ into the continuous phase, some of the CaCl₂ grains were crushed with a spatula, which resulted in formation of a rigid mass containing the alginate/Ca²⁺ complex and water.

### Example 6

### Reducing Slurry Fluidity by Destabilizing Emulsion

The fluidity of an HSCF slurry was significantly reduced by destabilizing a PLA emulsion used as a carrier fluid for a tri-modal solid particle mixture. The emulsion used was LANDY™ PL-1000 produced by Miyoshi Oil & Fat Co., Ltd. The emulsion contains fine PLA droplets suspended in an aqueous solution having a mass content of approximately 40%. The composition of the mixture is given in Table 4 below:

TABLE 4

| Multi-modal composition | Fluid |
|---|---|
| CarboProp 16/20 Proppant | 9 ml of commercial |
| 0.584-0.838 mm 28 g | LANDY ™ PL-1000 |
| CaCO₃ (mean diameter 101 | emulsion. |
| microns) 7.5 g | |
| CaCO₃ (mean diameter 8.0 | |
| microns) 5.5 g | |

After addition of 2 ml of a 1:1 volume:volume mixture of organic solvents (butoxyethanol and DBE-2 (dibasic ester-2 (which is 24% dimethyl adipate and 75% dimethyl glutarate) available from Invista)) there was a significant reduction in the fluidity of the slurry.

### Example 7

### Decrosslinking Alginate/Ca²⁺ Complex with Acid

A sample of particles of the alginate/Ca²⁺ complex of Example 2 was divided into two equal 20 g portions. These portions were each placed in 100 ml SHOTT bottles with screw lids with 50 ml of deionized water. 0.5 g of 1.0 to 0.4 mm (18/40 mesh) PLA was added to one bottle. The bottles were heated in an oven at 104° C. (219° F.) for 10 days. Upon removal from the oven, the liquids in both bottles had a brown color. No solids remained in the bottle that had contained PLA particles. The alginate/Ca²⁺ complex in the bottle without PLA appeared to have a volume similar to that before heating.

### Example 8

### Increasing the Viscosity of the Continuous Fluid of an HSCF

The fluidity of a High Solids Content Fluid was significantly increased by crosslinking of the continuous phase. The composition of the mixture is given in Table 5 below:

TABLE 5

| | Carrier | |
|---|---|---|
| | fluid (low | |
| Multi-modal composition | viscosity) | Crosslinker |
| CarboProp 16/20 Proppant | 9 ml of | 0.5 ml borate solution |
| (0.584 to 0.838 mm) 28 g | 1.2% guar | prepared by |
| CaCO₃ (mean diameter 101 | solution in | dissolving 6 g H₃BO₃, |
| microns) 7.5 g | water | 10 g NaOH and 18 g of |
| CaCO₃ (mean diameter 8.0 | | sodium gluconate in |
| microns) 5.5 g | | 70 ml water |

Addition of the crosslinker caused the slurry to form a solid.

### Example 9

### Preparing a Plug by Increasing the Viscosity of a Slurry

This example shows the advantages of both high solids content, which is possible with suitable multimodal distributions of particles, and generation of a high viscosity in the continuous phase to making a high strength plug. To illustrate the benefits of using HSCF's for seal generation, the performance of plugs formed from fluids of various compositions have been evaluated. The plugs formed from HSCF's containing particles having three sizes showed the highest stability to displacement with hydraulic pressure in these experiments.

The laboratory setup shown in FIG. 2 was used. The apparatus and its operation were described in Example 4. Plug stability pressure was defined as the pressure across the cell which resulted in fluid flow through the cell at a pumping rate of 10 ml/min. The crosslinker was a borate solution prepared by dissolving 6 g H₃BO₃, 10 g NaOH and 18 g sodium gluconate in 70 ml of water; 1 ml of this crosslinker was added per 20 ml of carrier fluid in each experiment. Table 6 below gives the details of the experiments performed:

TABLE 6

| | High Solids Content Fluid | | |
|---|---|---|---|
| | | Carrier | Plug |
| | | fluid (low | stability |
| | Solid phase | viscosity) | limit |
| 1 | None | 100% by | ~55 kPa |
| | | volume: | (~8 psi) |
| | | 1.8% guar | |
| | | solution in | |
| | | deionized | |
| | | water | |
| 2 | 15% by volume* | 85% by | ~76 kPa |
| | For each 100 g of solid phase | volume: | (~11 psi) |
| | 20/40 Sand (mean diameter 616 microns, | 1.6% guar | |
| | SG = 2.65) 93.7 g | solution in | |
| | PLA fiber (SG = 1.25, length 6 mm, | deionized | |
| | diameter 14 microns) 6.3 g | water | |
| 3 | 60% by volume | 40% by | >1.034 MPa |
| | For each 100 g of solid phase: | volume: | (>150 psi) |
| | 20/40 Sand (mean diameter 616 microns, | 1.2% guar | |
| | SG = 2.65) 61 g | solution in | |
| | 100 mesh sand (mean diameter 101 | deionized | |
| | microns, SG = 2.65) 19 g | water | |
| | CaCO₃ (mean diameter 8.0 microns, | | |
| | SG = 2.65) 20 g | | |

*In experiment 2 (with a fluid that contained only 15% of 20/40 sand by volume) the PLA fiber was added to suspend the sand in the fluid before crosslinking.

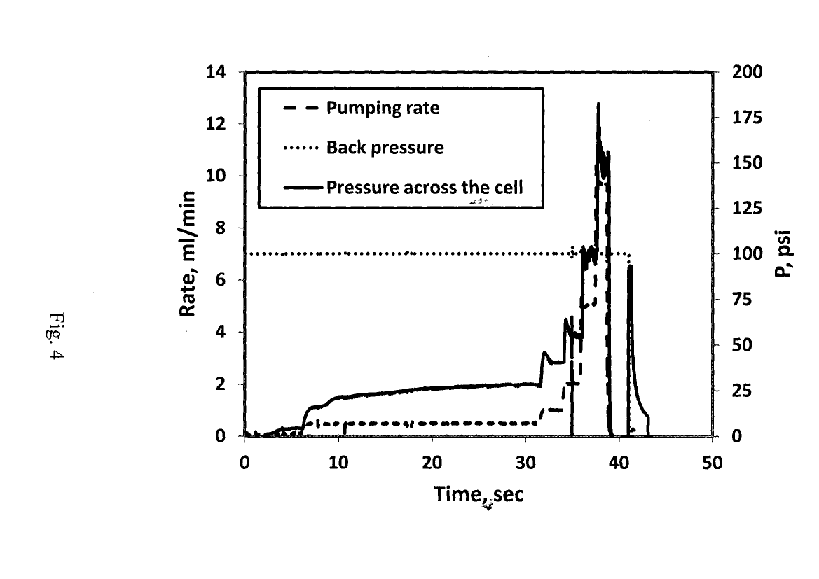

FIG. 4 shows the pumping rate as it was increased stepwise, and the pressure profile measured, during attempted displacement of the plug made from the HSCF of experiment 3. Although fluid was flowing through the plug at a rate of 10 ml/min at a differential pressure across the cell of about 1.03 MPa (about 150 psi) there was no sign of plug displacement when the cell was taken apart after the experiment. Upon opening the apparatus, it was seen that the plug completely filled the pipe, producing a very tight plug; leaking occurred due to imperfect contact between the walls of the pipe and the plug. The results of these experiments showed that the plug formed from the slurry that contained the highest solids content showed the greatest stability to displacement with hydraulic pressure. Note that it is not possible to formulate a slurry that flows but contains more than about 60 volume % solids if the solid particles are all the same size; the only way to make a flowable high-solids-content slurry is to use particles with some specific particle size distribution so that medium, fine, etc. particles fill the pore spaces between the larger particles.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

We claim:

1. A method of reducing the flow of a treatment fluid in a well comprising a wellbore penetrating a subterranean formation, comprising preparing a slurry comprising a high solids content fluid comprising a carrier fluid and solids having a multi-model size distribution, injecting the high solids content fluid into the well, placing the high solids content fluid at the location at which fluid flow is to be decreased, and reducing the volume of the carrier fluid.

2. The method of claim 1, wherein the reduction of treatment fluid flow occurs in the wellbore.

3. The method of claim 1, wherein the formation comprises one or more locations selected from the group consisting of fractures, vugs, wormholes and perforations and the reduction of treatment fluid flow occurs in one or more than one of the locations.

4. The method of claim 1, wherein at least a portion of the solids having a multi-model size distribution is removable.

5. The method of claim 1, wherein the reduction in volume of the carrier fluid is caused by a mechanism selected from the group consisting of carrier fluid absorption by absorbing agents, reaction of the carrier fluid with at least one of the solid components of the slurry to form additional solids, carrier fluid leak-off, precipitation of part of the carrier fluid to form additional solids, and breakdown of a multi-phase carrier fluid.

6. The method of claim 5, wherein at least a portion of the solids selected from the group consisting of the additional solids formed from reaction of the carrier fluid with at least one of the solid components of the slurry, and the additional solids formed from precipitation of part of the carrier fluid, is removable.

7. The method of claim 1, wherein the carrier fluid further comprises a fiber.

8. The method of claim 1, wherein the reduction of treatment fluid flow provides zonal isolation.

9. The method of claim 1, wherein the reduction of treatment fluid flow provides treatment fluid flow diversion.

10. A method of reducing the flow of a treatment fluid in a well comprising a wellbore penetrating a subterranean formation, comprising preparing a slurry comprising a high solids content fluid comprising a carrier fluid comprising a viscosifying agent and solids having a multi-model size distribution, injecting the high solids content fluid into the well, placing the high solids content fluid at the location at which fluid flow is to be decreased, and increasing the viscosity of the carrier fluid.

11. The method of claim 10, wherein the reduction of treatment fluid flow occurs in the wellbore.

12. The method of claim 10, wherein the formation comprises one or more locations selected from the group consisting of fractures, vugs, wormholes and perforations and the reduction of treatment fluid flow occurs in one or more than one of the locations.

13. The method of claim 10, wherein at least a portion of the solids having a multi-model size distribution is removable.

14. The method of claim 10, wherein the increase of viscosity is caused by a mechanism selected from the group consisting of crosslinking the viscosifying agent, reaction between the carrier fluid and the formation, changing the carrier fluid salinity, and changing the carrier fluid pH.

15. The method of claim 10, wherein the carrier fluid further comprises a fiber.

16. The method of claim 10, wherein the reduction of treatment fluid flow provides zonal isolation.

17. The method of claim 10, wherein the reduction of treatment fluid flow provides treatment fluid flow diversion.
